(19) United States
(12) Patent Application Publication
(10) Pub. No.: US 2026/0250016 A1
(43) Pub. Date: Aug. 27, 2026

(54) AIRCRAFT EMERGENCY BROADCAST SYSTEM

(71) Applicant: Skyway Technologies Corp., Pleasanton, CA (US)

(72) Inventors: Clifford FERNANDEZ, New York, NY (US); Derrick Harry Lewis, New York, NY (US); Brooke Webster, Long Beach, CA (US); Noah Reef, Cathedral city, CA (US)

(21) Appl. No.: 19/545,910

(22) Filed: Feb. 20, 2026

Related U.S. Application Data
(60) Provisional application No. 63/761,442, filed on Feb. 21, 2025.

(51) Int. Cl. B64D 45/00; B64U 20/80

(52) U.S. Cl. CPC B64D 45/00; B64U 20/80; B64D 2045/0065

(57) ABSTRACT

An emergency broadcast mechanism that can quickly and efficiently alert aircraft that surround an unmanned aerial vehicle (UAV) of an emergency event or situation at the UAV is described. For example, a UAV flying above other UAVs may experience a distress situation, and immediately or subsequently broadcast a distress signal to the other UAVs after an initial freefall from its original altitude, alerting the other UAVs to the distress situation. The other UAVs may modify their operations to avoid colliding with the falling UAV, such as by adjusting their flight trajectories or otherwise performing an action to avoid a possible collision with the falling UAV.

### CROSS-REFERENCE TO RELATED APPLICATIONS

This application claims priority to U.S. Provisional Patent Application No. 63/761,442, filed on February 21, 2025, entitled AIRCRAFT EMERGENCY BROADCAST SYSTEM, which is hereby incorporated by reference in its entirety.

### BACKGROUND

Drones and other UAVs (Unmanned Aerial Vehicles), such as vertical take-off and landing (VTOL) aircraft, have many different uses, including surveillance, package delivery, remote sensing, exploration and monitoring of locations, construction and surveying applications, and so on. While the control and management of individual drones can be managed, scenarios or operations that utilize many UAVs (e.g., hundreds of UAVs in a location) can introduce complexities and issues relating to the utilization, control, navigation, and/or management of the UAVs, among other drawbacks.

### BRIEF DESCRIPTION OF THE DRAWINGS

FIG. 1 is a diagram illustrating an example distress scenario between UAVs.

FIG. 2 is a diagram illustrating an environment for broadcasting distress information between UAVs.

FIG. 3 is a flow diagram illustrating a method performed by a UAV.

FIG. 4 is a flow diagram illustrating another method performed by a UAV.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Systems and methods for broadcasting emergency information between UAVs are described. Typically, UAVs utilize various safety systems, such as a traffic alert and collision avoidance system (TCAS), an airborne collision avoidance system (ACAS), and so on, to monitor airspace and reduce, mitigate, and/or prevent collisions (e.g., mid-air collisions, or MACs). However, such systems may involve complex mechanisms for monitoring an airspace, such as by using complex sensors, imaging, and so on.

The systems and methods described herein seek to provide a simple, immediate, emergency broadcast mechanism that can quickly and efficiently alert aircraft that surround a UAV of an emergency event or situation at the UAV. For example, a UAV flying above other UAVs may experience a distress situation, and immediately or subsequently broadcast a distress signal to the other UAVs after an initial freefall from its original altitude, alerting the other UAVs to the distress situation. The other UAVs (e.g., via internal TCASs), may modify their operations to avoid colliding with the falling UAV, such as by adjusting their flight trajectories or otherwise performing an action to avoid a possible collision with the falling UAV.

As described herein, the systems and methods may be utilized and/or supported by various types of UAVs, including drones, VTOL aircraft (e.g., electric VTOLs, or eVTOLs), and so on.

In the following description, for the purposes of explanation, numerous specific details are set forth in order to provide a thorough understanding of implementations of the present technology. It will be apparent, however, to one skilled in the art that implementations of the present technology can be practiced without some of these specific details. The phrases "in some implementations," "according to some implementations," "in the implementations shown," "in other implementations," and the like generally mean the particular feature, structure, or characteristic following the phrase is included in at least one implementation of the present technology and can be included in more than one implementation. In addition, such phrases do not necessarily refer to the same implementations or different implementations.

### Examples of the Emergency Broadcast System

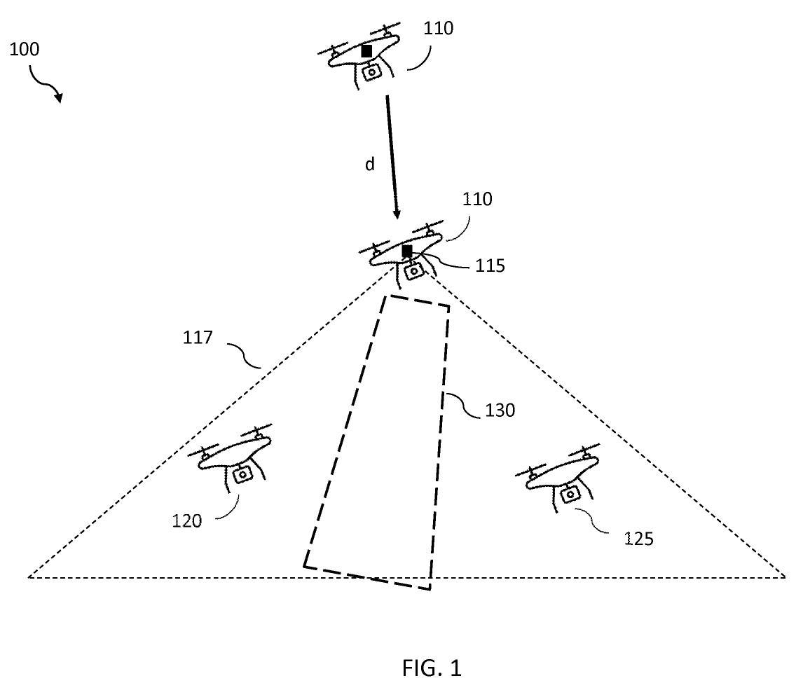

As described herein, the systems and methods provide an emergency broadcast system and mechanism for UAVs, such as a hive broadcast system. FIG. 1 is a diagram 100 illustrating an example distress scenario between UAVs.

A UAV 100 undergoes an emergency or distress event (e.g., loss of power, loss of signal, high winds, collision with an object, software errors, pilot errors, and so on). The UAV 110, during the distress event, drops in altitude over a certain distance “d” within or after a certain time period (e.g., 1, 2, or 3 seconds). For example, the UAV 110 dropping (e.g., moving in a vertical direction) between 50-150 feet for a minimum of one or two seconds may indicate the UAV 110 is no longer in control and is falling (e.g., freefalling) downwards in a vertical direction. Thus, in some cases, the abnormal movement of the UAV 110 may be a movement or action that mimics or indicates freefall, such as when the UAV 110 maintains a threshold velocity of 50-150 feet/second (e.g., or other values, depending on the size and/or weight of the UAV 110). Other movements, such as natural or regular movements downwards (due to winds, turbulence, or other microbursts) may not be indicative of a distress situation at the UAV 110.

The UAV 110 detects and/or identifies its movement as being abnormal and triggers a broadcast of a signal to other UAVs 120 and 125 that are located below the UAV 110. For example, the UAV 110 may cause a beacon 115 to transmit an emergency beacon signal 117 to an airspace that surrounds the UAV 110, regardless of whether other aircraft are within the airspace. As shown, the two UAVs 120, 125 are below the UAV 110 and within the airspace, and thus in a possible collision path (e.g., a determined and/or predicted hazard envelope 130) with the UAV 110 as it falls downwards. However, the UAVs 120, 125 receive the emergency beacon signal 117, and can alter their movement (e.g., flight paths, trajectories, and so on) to avoid a MAC (or near-MAC) with the falling UAV 110.

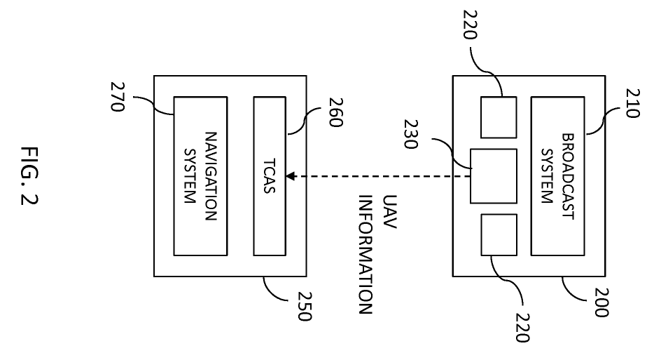

FIG. 2 is a diagram illustrating the broadcast of distress information between UAVs. A UAV 200 (e.g., the UAV 110) is in distress and falls a certain threshold distance (within a certain time period), which is detected by one or more sensors 220 (e.g., accelerometers, actuators, gyroscopes, IMUs (inertial measurement units), and so on).

A broadcast system 210 may trigger a beacon 230 or other module to transmit a distress signal based on determining an abnormal event at the UAV 200. For example, the sensors may capture information representing a distance traveled by the UAV 200, a velocity of the UAV 200 (in one or more directions), an acceleration of the UAV 200, a rotation of the UAV 200, and so on, which may represent an abnormal event (e.g., distress event) at the UAV 200.

In some cases, the system 210 may utilize the captured information to identify or track a new trajectory (e.g., the freefall of the UAV 200) and/or compare the new trajectory with a known or predicted trajectory to determine or confirm the movement of the UAV 200 is an abnormal movement that indicates the occurrence of the abnormal event at the UAV 200.

The system 210, therefore, may include a trigger module that detects an abnormal movement (e.g., abnormal vertical movement downwards) of the UAV 200 and a signal module that transmits a signal in response to the detected abnormal movement of the UAV 200. The components and/or modules of the system 210 can be implemented with a combination of software (e.g., executable instructions, or computer code) and hardware (e.g., at least a memory and processor). Accordingly, as used herein, in some embodiments, a component/module is a processor-implemented component/module and represents a computing device having a processor that is at least temporarily configured and/or programmed by executable instructions stored in memory to perform one or more of the functions that are described herein.

For example, the signal module may transmit a broadcast or hive signal via the beacon 230. The signal may include UAV information associated with the UAV 200, such as an identifier of the UAV 200, an automatic dependent surveillance-broadcast (ADS-B) location of the UAV 200, an altitude of the UAV 200, information associated with the movement of the UAV 200, and so on. In some cases, the signal may include a distress alert indication along with UAV information (e.g., an information package for the distress alert or event).

In some examples, the broadcast system 210 may perform predictive airspace hazard/distress modeling to dynamically, continuously, and/or periodically determine a real-time (or near real-time) impact corridor or area for the abnormal movement of the UAV 200. For example, the system 210 may determine and/or predict a projected ballistic descent path (e.g., within the hazard envelope 130), estimating a possible impact volume, determining a descending 3D hazard or impact corridor (or area), and/or continuously, during its movement, the determined impact corridor. The impact corridor may comprise, in some cases, a dynamically determined hazard envelope (e.g., the hazard envelope 130), associated and/or predicted impact time window (e.g., a time within the envelope), a confidence score of the prediction, and so on.

The broadcast system 210 may broadcast such information (e.g., for the determined impact corridor and/or determined hazard envelope) via the beacon 230. In some cases, the broadcast information may include or identify various levels of distress that indicate, via a distress classification framework, a level of distress at the UAV 200. For example, the broadcast information may include the following example distress level indications: “Level 1: degraded performance,” “Level 2: partial thrust loss,” “Level 3: imminent uncontrolled descent,” “Level 4: fragmentation event,” and so on.

The system 200 may determine a distress level based on the captured information and/or other sensor-based information (e.g., information from a computing system, controller, motor, battery, and so on, of the UAV 200). Further, the system 200 may provide a different level of data density, trigger different avoidance logic, and/or activate a different broadcast power and/or density (e.g., the size, scale, shape, radius, and/or power) of the emergency beacon signal 117.

A UAV 250 located proximate to (e.g., below) the UAV 200 receives the distress signal (e.g., a signal containing UAV information) via an internal TCAS 260. Via the TCAS 260, a navigation system 270 automatically or dynamically modifies a current trajectory of the UAV 250 based on the received distress signal. For example, the navigation system 270, which may include or be associated with the TCAS 260, may adjust a current flight path of the UAV 250. In some cases, other types of aircraft or airborne devices (e.g., manned aircraft, helicopters, and/or other flying objects) may be configured to receive the distress signal from the UAV 200.

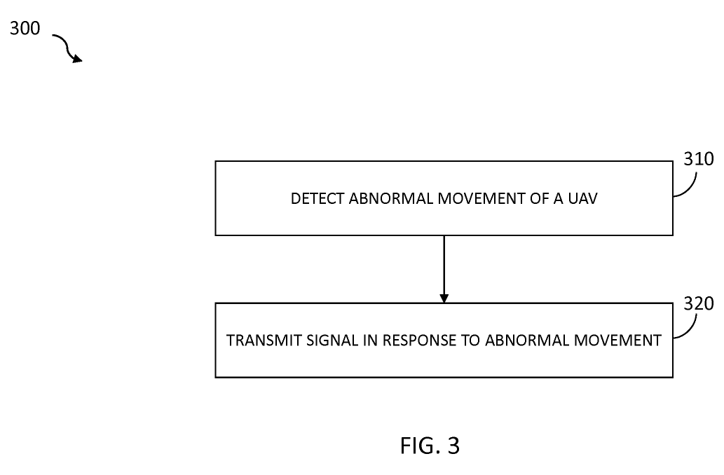

As described herein, the UAV 200 (e.g., UAV 110) may perform various methods or processes to immediately signal a distress situation to other UAVs within a certain proximity to the UAV. FIG. 3 is a flow diagram illustrating a method 300 performed by the UAV 200. The method 300 may be performed by the broadcast system 210 and, accordingly, is described herein merely by way of reference thereto. It will be appreciated that the method 300 may be performed on any suitable hardware.

In operation 310, the broadcast system 210 detects an abnormal movement of the UAV 200. For example, a trigger module may receive information from the sensors 220 that indicates the UAV 200 (e.g., a center of gravity of the UAV 200) has moved downwards over a certain distance (e.g., above or satisfying a threshold distance) with a certain time period. As an example, sensor information that indicates a sustained movement of the UAV 200 of at least 50-150 feet/second for two or more seconds satisfies a threshold movement and would be indicative of abnormal movement, with respect to other movement (e.g. due to wind or predicted navigation) that is not as fast and/or has a shorter duration.

In some cases, the trigger module may detect the abnormal movement of the UAV based on a current velocity of the UAV satisfying a threshold velocity associated with a distress event at the UAV (e.g., the velocity has a magnitude and/or direction within a range of values that indicates abnormal movement, such as freefall), based on a current acceleration of the UAV satisfying a threshold acceleration associated with a distress event at the UAV (e.g., the acceleration has a magnitude and/or direction within a range of values that indicates abnormal movement, such as freefall and/or a change in direction), based on a current rotation of the UAV satisfying a threshold rotation associated with a distress event at the UAV (e.g., the rotation (e.g., direction, speed, angular momentum, and so on) indicates an abnormal movement), and so on.

In operation 320, the broadcast system 210 transmits or broadcasts a signal in response to the detected abnormal movement of the UAV 200, For example, the signal module may cause a transmission or broadcast of an emergency beacon signal to a three-dimensional (3D) space under the UAV. In some cases, the signal includes an information package of information, including an identifier for the UAV, an ADS-B location of the UAV, current trajectory information (e.g., a velocity or rate of descent) for the UAV, and so on.

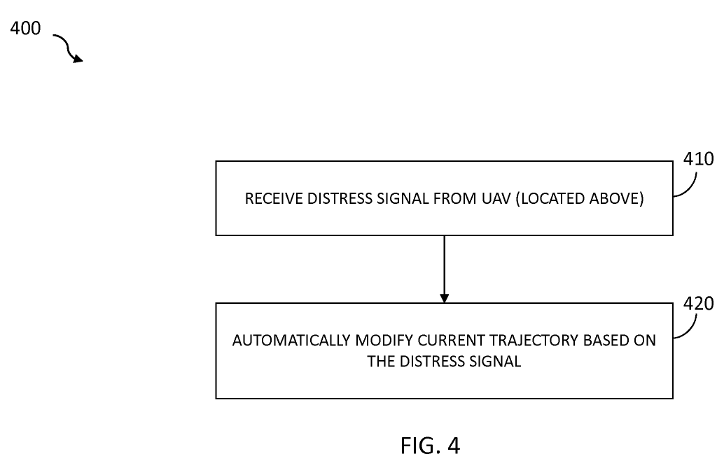

As described herein, aircraft (e.g., the UAV 250) under the UAV 200 may perform various methods and processes to avoid the UAV 200 as it travels downwards. FIG. 4 is a flow diagram illustrating a method 400 performed by the UAV 250. The method 400 may be performed by the navigation system 270 and, accordingly, is described herein merely by way of reference thereto. It will be appreciated that the method 400 may be performed on any suitable hardware.

In operation 410, the navigation system 270 receives a distress signal from another UAV located above the UAV 250. For example, the UAV 250 may receive, via the TCAS 260, an emergency beacon signal broadcast from the UAV 200.

In operation 420, the navigation system 270 automatically modifyies a current trajectory based on the received distress signal. For example, the system 270 may cause the UAV 250 to adjust or alter a current direction, speed, velocity, or path of travel to avoid a location via which the UAV 200 may be falling (e.g., based on information within the distress signal).

In some examples, the UAV 200, via the broadcast system 210, may include components configured to communicate information about abnormal events and/or performed actions to various entities, servers, and/or regulatory systems. For example, the broadcast system 210 may transmit, along with a distress broadcast, information to an unmanned aircraft system traffic management (UTM) server, regional airspace management systems, automated issuances (e.g. notices to air missions (NOTAMs)), ground infrastructure, and so on. Information within the broadcast signal (or additional signals) may include a snapshot of a last N seconds of telemetry data, a failure mode signature, one or more maintenance flags or codes, battery telemetry information, and other possible cause or event data).

Thus, in various embodiments, the systems and methods described herein facilitate an immediate and efficient signaling of a distress situation, event, or scenario at a UAV, enabling other UAVs, which may be proximate to the UAV, from being affected (e.g., collided with) by the distress situation. The systems and methods, employing a simple broadcast mechanism, may provide immediate signaling to an area surrounding the UAV (with or without UAVs), which can prevent other UAVs from traveling into a dangerous situation and/or remaining in a dangerous situation, among other benefits.

### Examples of the Disclosed Technology

As described herein, the disclosed technology may be implemented in a variety of ways, as follows.

In some examples, a system (e.g., with a processor and memory) and/or method associated with a UAV may include a trigger module that detects an abnormal movement of the UAV and a signal module that transmits a signal in response to the detected abnormal movement of the UAV.

In some cases, the abnormal movement of the UAV is a movement of the UAV downwards and over a threshold distance within a certain time period, such as a sustained movement of the UAV of at least 50-150 feet/second for two or more seconds.

In some cases, the signal module causes transmission of an emergency beacon signal to a three-dimensional (3D) space under the UAV.

In some cases, the signal includes a package of information, including: an identifier of the UAV, an automatic dependent surveillance-broadcast (ADS-B) location of the UAV, and/or trajectory information for the UAV.

In some cases, the trigger module detects the abnormal movement of the UAV based on a current velocity of the UAV satisfying a threshold velocity associated with a distress event at the UAV.

In some cases, the trigger module detects the abnormal movement of the UAV based on a current acceleration of the UAV satisfying a threshold acceleration associated with a distress event at the UAV.

In some cases, the trigger module detects the abnormal movement of the UAV based on a current rotation of the UAV satisfying a threshold rotation associated with a distress event at the UAV.

In some examples, a system (e.g., with a processor and memory) and/or method associated with a UAV may include receiving a distress signal from another UAV located above the UAV and automatically modifying a current trajectory based on the received distress signal.

In some cases, a traffic collision avoidance system (TCAS) receives the distress signal and automatically modifies the current trajectory of the UAV.

In some cases, the distress signal includes an identifier of the UAV, an automatic dependent surveillance-broadcast (ADS-B) location of the UAV, and/or trajectory information for the UAV.

### Conclusion

The Figures and components depicted herein provide a general computing environment and network within which the system can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD–ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The network can be any network, ranging from a wired or wireless local area network (LAN) to a wired or wireless wide area network (WAN), to the Internet or some other public or private network. While the connections between the system and other aspects are shown as separate connections, these connections can be any kind of local, wide area, wired, or wireless network, public or private.

Further, any or all components depicted in the Figures described herein can be supported and/or implemented via one or more computing systems or servers. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” "host," and "host computer," and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the system may reside on a server computer, while corresponding portions may reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

The systems may be implemented with a combination of software (e.g., executable instructions, or computer code) and hardware (e.g., at least a memory and processor). Accordingly, as used herein, in some example embodiments, a component or module of the navigation system 120 is a processor-implemented module/component and represents a computing device having a processor that is at least temporarily configured and/or programmed by executable instructions stored in memory to perform one or more of the particular functions that are described herein.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling of connection between the elements can be physical, logical, or a combination thereof. Additionally, the words "herein," "above," "below," and words of similar import, when used in this application, shall refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks, or employ systems having blocks, in a different order; and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the methods and system provided herein can be applied to other systems, not necessarily the system described above. The elements, blocks and acts of the various implementations described above can be combined to provide further implementations.

Any patents, applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

We claim:

1. A system associated with an unmanned aerial vehicle (UAV), the system comprising:
a trigger module that detects an abnormal movement of the UAV; and
a signal module that transmits a signal in response to the detected abnormal movement of the UAV.

2. The system of claim 1, wherein the abnormal movement of the UAV is a movement of the UAV downwards and over a threshold distance within a certain time period.

3. The system of claim 1, wherein the signal module causes transmission of an emergency beacon signal to a three-dimensional (3D) space under the UAV.

4. The system of claim 1, wherein the signal includes a package of information, including:
an identifier of the UAV; and
an automatic dependent surveillance-broadcast (ADS-B) location of the UAV.

5. The system of claim 1, wherein the signal includes a package of information, including:
an identifier of the UAV;
an automatic dependent surveillance-broadcast (ADS-B) location of the UAV; and
trajectory information for the UAV.

6. The system of claim 1, wherein the trigger module detects the abnormal movement of the UAV based on a current velocity of the UAV satisfying a threshold velocity associated with a distress event at the UAV.

7. The system of claim 1, wherein the trigger module detects the abnormal movement of the UAV based on a current acceleration of the UAV satisfying a threshold acceleration associated with a distress event at the UAV.

8. The system of claim 1, wherein the trigger module detects the abnormal movement of the UAV based on a current rotation of the UAV satisfying a threshold rotation associated with a distress event at the UAV.

9. A method performed by an unmanned aerial vehicle (UAV), the method comprising:
receiving a distress signal from another UAV located above the UAV; and
automatically modifying a current trajectory based on the received distress signal.

10. The method of claim 9, wherein a traffic collision avoidance system (TCAS) receives the distress signal and automatically modifies the current trajectory of the UAV.

11. A method of claim 9, wherein the distress signal includes:
an identifier of the UAV;
an automatic dependent surveillance-broadcast (ADS-B) location of the UAV; or
trajectory information for the UAV.

12. A non-transitory computer-readable medium whose contents, when executed by a computing system of an unmanned aerial vehicle (UAV), cause the computing system to perform a method, the method comprising:
detecting an abnormal movement of the UAV; and
broadcasting a signal in response to the detected abnormal movement of the UAV.

13. The computer-readable medium of claim 12, wherein the abnormal movement of the UAV is a movement of the UAV downwards and over a threshold distance within a certain time period.

14. The computer-readable medium of claim 12, wherein the abnormal movement is a sustained movement of the UAV of at least 50-150 feet/second for two or more seconds.

15. The computer-readable medium of claim 12, wherein the signal is an emergency beacon signal broadcast to a three-dimensional (3D) space under the UAV.

16. The computer-readable medium of claim 12, wherein the signal includes a package of information, including:
an identifier of the UAV; and
an automatic dependent surveillance-broadcast (ADS-B) location of the UAV.

17. The computer-readable medium of claim 12, wherein the signal includes a package of information, including:
an identifier of the UAV;
an automatic dependent surveillance-broadcast (ADS-B) location of the UAV; and
trajectory information for the UAV.

18. The computer-readable medium of claim 12, wherein detecting the abnormal movement of the UAV is based on a current velocity of the UAV satisfying a threshold velocity associated with a distress event at the UAV.

19. The system of claim 1, wherein detecting the abnormal movement of the UAV is based on a current acceleration of the UAV satisfying a threshold acceleration associated with a distress event at the UAV.

20. The system of claim 1, wherein detecting the abnormal movement of the UAV is based on a current rotation of the UAV satisfying a threshold rotation associated with a distress event at the UAV.
